(19) United States
(12) Patent Application Publication
(10) Pub. No.: US 2006/0130445 A1
(43) Pub. Date: Jun. 22, 2006

(54) Cyclone air purifier

(76) Inventors: Chan Jung Park, Suwon-City (KR); Young Saeng Kim, Incheon-City (KR)

Correspondence Address: STANZIONE & KIM, LLP, 919 18TH STREET, N.W., SUITE 440, WASHINGTON, DC, 20006, US

(21) Appl. No.: 11/221,871

(22) Filed: Sep. 9, 2005

(30) Foreign Application Priority Data
Dec. 16, 2004 (KR) 2004-107402

(51) Int. Cl. B01D 45/12

(52) U.S. Cl. 55/346

(57) ABSTRACT

A cyclone air purifier having a large capacity and a compact structure by disposing a plurality of cyclones effectively therewithin includes a first main body of cylindrical shape having upper and lower plates to form an air path therebetween and a side plate formed with a plurality of inlet holes through which an outside air is introduced into the air path, and a plurality of cyclone bodies disposed parallel to one another in the first main body to communicate with the air path, and having an upper portion disposed in an opening of the upper plate, and a lower portion to pass through the lower plate to form a first discharging unit. The cyclone air purifier includes a cyclone cover unit having a plurality of cover portions to cover corresponding ones of the openings of the upper plates. Each cover portion includes a second discharging unit, a discharging guide unit is installed at an upper portion of the first main body, and a ventilation fan and an air filter are installed within the discharging guide unit.

### CROSS-REFERENCE TO RELATED APPLICATIONS

This application claims the benefit under 35 U.S.C. §119 of Korean Patent Application No. 2004-107402, filed on Dec. 16, 2004, in the Korean Intellectual Property Office, the disclosure of which is incorporated herein in its entirety by reference.

### BACKGROUND OF THE INVENTION

1. Field of the Invention

The present general inventive concept relates to an air purifier, and more particularly, to an air purifier using a cyclone apparatus.

2. Description of the Related Art

A cyclone apparatus is a device used to remove solid or liquid particles from air, and uses a principle (cyclone principle) by which particles contained in the air are separated from the air due to a centrifugal force. Examples of the cyclone apparatus are disclosed in Korean Patent Application Laid-Open No.: 2004-44297, 2003-94872, 2002-78798, etc.

Generally, a conventional air purifier uses a plurality of plate-shaped filters, sucks in the air through a front side, and discharges purified air through a top or side. The conventional air purifier sucks in the air through the front side only and has problems in that an amount of the air flowing into the conventional air purifier is relatively small due to the plurality of plate-shaped filters, and resistance against the flowing air and noise generated from the conventional air purifier becomes greater since the air passes through a structure having the plurality of plate-shaped filters. Moreover, the filters should frequently be cleaned or replaced since dust accumulates in the filters during a longer period of usage of the conventional air purifier. Furthermore, a capacity of air purification is limited in the conventional air purifier since the air passes through the filters attached with the dust.

### SUMMARY OF THE INVENTION

In order to solve the foregoing and/or other problems, it is an aspect of the present general inventive concept to provide an air purifier using a cyclone principle.

It is another aspect of the present general inventive concept to provide a cyclone air purifier to improve a capacity of air purification and to increase an amount of air flowing in an inside of the cyclone air purifier.

It is another aspect of the present general inventive concept to provide a cyclone air purifier having a large capacity and a compact structure by disposing a plurality of cyclones effectively within the cyclone air purifier.

It is another aspect of the present general inventive concept to provide a cyclone air purifier to reduce noise and pressure loss occurring due to a resistance against the air flowing in the cyclone air purifier.

It is another aspect of the present general inventive concept to provide a cyclone air purifier having a plurality of cyclones formed by combining cyclone bodies and a cover unit in an integrated single body, thereby improving a manufacturing process.

It is another aspect of the present general inventive concept to provide a cyclone air purifier to reduce the number of cleaning or replacement processes so that a user uses the cyclone air purifier with convenience.

Additional aspects and advantages of the present general inventive concept will be set forth in part in the description which follows and, in part, will be obvious from the description, or may be learned by practice of the general inventive concept.

In order to achieve the foregoing and/or other aspects of the present general inventive concept, there is provided a cyclone air purifier including a main body having an air path and a plurality of cyclones disposed parallel to one another therein to communicate with the air path, wherein the main body comprises a side plate having a plurality of inlet holes formed thereon to introduce an outside air containing particles into the air path of the main body, and each of the plurality of cyclones comprises a first discharging unit formed on a lower portion thereof to guide discharge of the particles which are separated from the air, and a second discharging unit formed on an upper portion thereof to discharge the air.

The cyclone air purifier may further include a plurality of guide units to guide the air of the air path into an inside of each of the plurality of cyclones.

Each of the guide units may be formed around the second discharging unit of each of the plurality of cyclones. In the cyclone air purifier, each of the guide units may include a first guide groove disposed on an outside of a corresponding one of the plurality of cyclones to communicate with the air path, a guide duct to guide the air introduced into the first guide groove toward the corresponding one of the plurality of cyclones, and a second guide groove extended from the guide duct to communicate with an inside of the corresponding one of the plurality of cyclones.

The first guide groove may have a first depth deeper than a second depth of the second guide groove, and the second guide groove may be formed to face an inside surface of the corresponding one of the plurality of cyclones. The first and second guide grooves may be disposed opposite to each other with respect to the second discharging unit.

The second discharge unit may include a lower protrusion to protrude downward toward an inside of the corresponding one of the plurality of cyclones.

The cyclone air purifier may further include a collector disposed on a lower portion of the main body to collect the separated particles discharged through the first discharging unit of the corresponding one of the plurality of cyclones.

The cyclone air purifier may further include a discharging guide unit disposed on an upper portion of the main body to receive the purified air from the plurality of cyclones and to discharge the received purified air, and a ventilation fan and a filter installed therein.

In the cyclone air purifier, the inlet holes may be dispersed and arranged on the side plate so that the outside air around the main body is sucked-in through the inlet holes. It is possible that the inlet holes are disposed along an entire circumference of the side plate.

The plurality of cyclones may be disposed on corresponding ones of a plurality of concentric circles.

In order to achieve the foregoing and/or other aspects of the present general inventive concept, there is provided a cyclone air purifier including a first main body having an upper plate, a lower plate to form an air path with the upper plate, a side plate formed with a plurality of inlet holes through which an outside air is introduced into the air path, and having a cylindrical shape, a plurality of cyclone bodies disposed parallel to one another in the first main body to communicate with the air path, and having an upper portion disposed in an opening of the upper plate, and a lower portion to pass through the lower plate to form a first discharging unit, and a second main body having cover portions to cover corresponding ones of the openings of the upper plates, and having second discharging units formed on the respective cover portions to guide discharge of purified air from a corresponding one of the plurality of cyclones.

The upper plate of the first main body and the plurality of cyclone bodies may be formed in an integrated single body, and the inlet holes may be dispersed and arranged on the side plate so that the outside air is sucked in directions throughout a circumstance of the side plate.

The second main body may further include a plate shape formed by combining the cover portions and the second discharging units in an integrated single body, and the plurality of cyclones may be disposed on corresponding ones of concentric circles.

### BRIEF DESCRIPTION OF THE DRAWINGS

FIG. 1 is an exploded view illustrating a cyclone air purifier according to an embodiment of the present general inventive concept;

FIG. 2 is a side cross-sectional view of the cyclone air purifier of FIG. 1;

FIG. 3 is a partial view of the cyclone air purifier of FIG. 1;

FIG. 4 is a plan view illustrating a cyclone cover unit of the cyclone air purifier of FIG. 1;

FIG. 5 is a bottom view illustrating a cyclone cover unit of the cyclone air purifier of FIG. 1;

FIG. 6 is a plan view illustrating an upper plate of a first main body unit of the cyclone air purifier of FIG. 1;

FIG. 7 is a cross-sectional view taken along a line VII-VII of FIG. 3 to illustrate a guide unit of the cyclone air purifier of FIG. 3;

FIG. 8 is an enlarged view illustrating a portion of the cyclone cover unit of the cyclone air purifier of FIG. 5; and

FIG. 9 is an enlarged view illustrating a portion of the upper plate of the cyclone air purifier of FIG. 6.

### DETAILED DESCRIPTION OF THE PREFERRED EMBODIMENTS

Hereinafter, a cyclone air purifier according to an embodiment of the present general inventive concept will be described in greater detail with reference with the accompanying drawings.

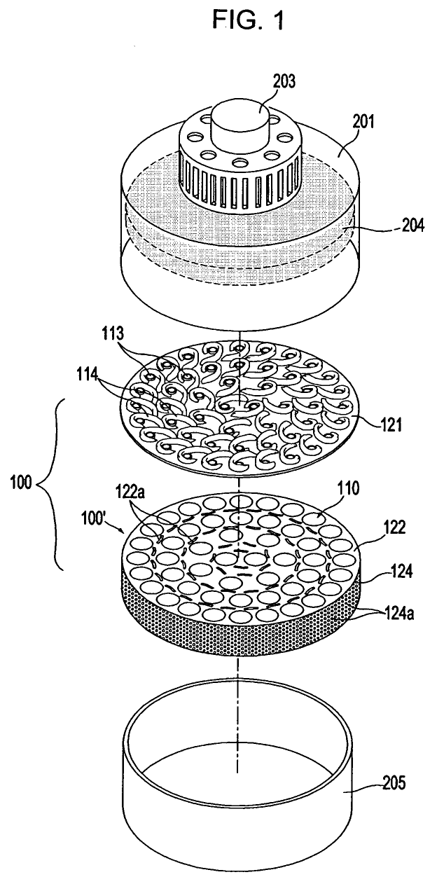

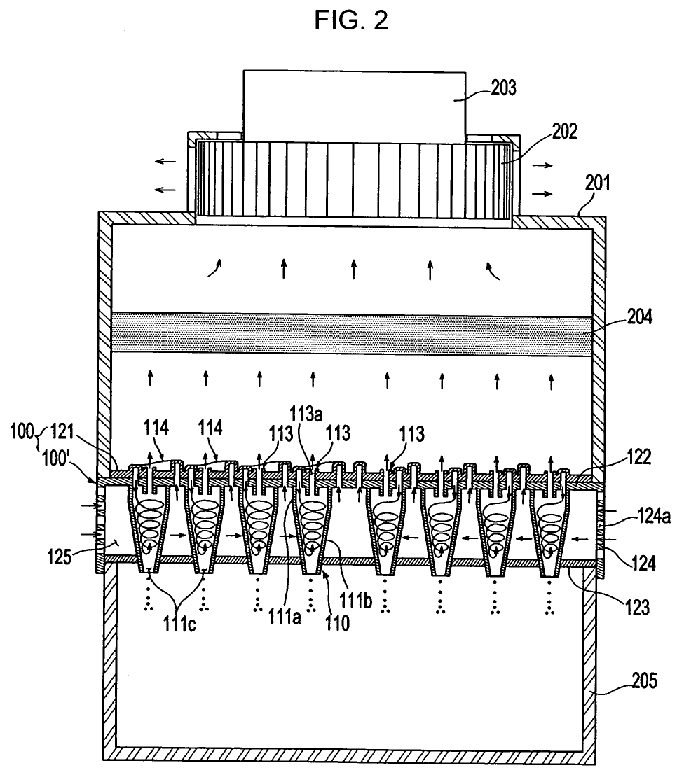

As shown in FIGS. 1 and 2, a cyclone air purifier according to an embodiment of the present general inventive concept includes a main body 100 formed with a plurality of cyclones 110 to purify air using a cyclone principle. A detail structure of the main body 100 will be described later.

The main body 100 includes a discharging guide unit (air outlet) 201 disposed on an upper portion thereof to guide the purified air to be discharged outside the cyclone air purifier. The discharging guide unit 201 is opened downward and connected to the main body 100, and includes a ventilation (discharge) fan 202 installed at an upper inside thereof, and a fan motor 203 installed at an upper side of the ventilation fan 202 to drive the ventilation fan 202. A lower side of the discharging guide unit 201 is fixedly connected to the upper portion of the main body 100.

An air filter 204 may be installed inside the discharging guide unit 201 to filter the air discharged from the main body 100. The air filter 204 filters minute dirt or dust particles which are contained in the air discharged from the main body and have not been removed by the main body 100. The air filter 204 may be detachably attached to the discharging guide unit 201 so that the air filter 204 is selectively used in or removed from the discharge guiding unit 201 if necessary. The air filter 204 can be used together with an optical catalytic filter or a deodorizing filter, or replaced with the optical catalytic filter or the deodorizing filter.

A dust collecting unit 205 of a cylindrical shape having an upper portion opened upward is installed at a lower portion of the main body 100. The dust collecting unit 205 collects various pollutants, such as the dust particles, etc., which are filtered (removed) from the main body 100. The dust collecting unit 205 can be detachably attached to the main body 100 so as to be cleaned up, and a drawer, such as a dust collecting box, to receive the pollutants can be disposed inside the dust collecting unit 205.

Hereinafter, the structure of the main body 100 will be described in detail. The main body 100 includes a first main body 100′ in which the plurality of cyclones 110 are disposed parallel to one another, and a cyclone cover unit 121 used as a second main body connected to an upper portion of the first main body 100′. The plurality of cyclones 110 may be disposed on corresponding ones of concentric circles in the first main body 100′. The cyclone cover unit (second main body) 121 includes a plurality of guide units 114 to guide the air discharged from the main body into corresponding insides of the plurality of cyclones 110, and a plurality of second discharging units 113 to discharge the filtered air by the corresponding ones of the plurality of cyclones 110.

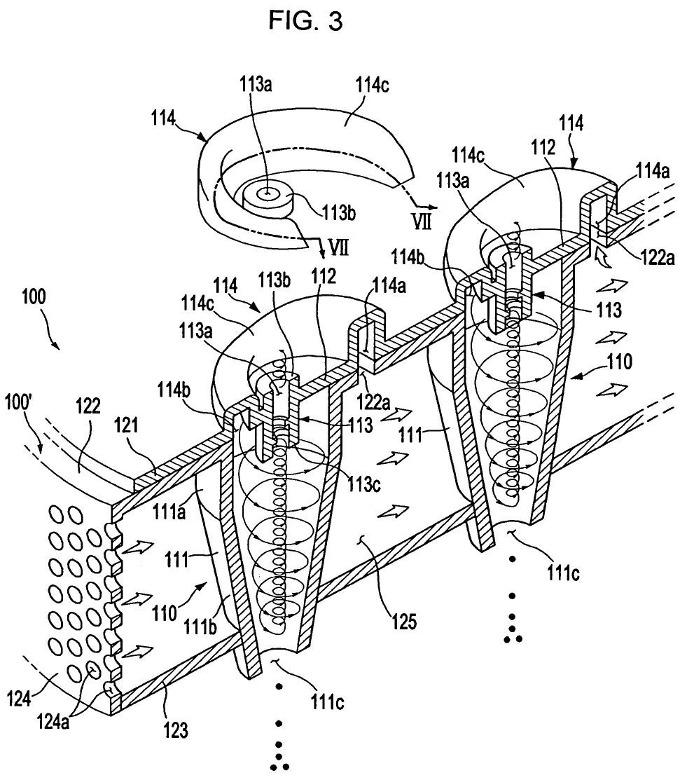

As shown in FIG. 3, the first main body 100′ includes an upper plate 122 attached to a lower surface of the cyclone cover unit 121, a lower plate 123 disposed to be spaced-apart from the upper plate 122 to support a lower portion of each of a plurality of cyclone bodies 111, and a side plate 124 disposed around a circumferential side between the upper plate 122 and the lower plate 123.

A plurality of inlet holes (air-suction holes) 124a are formed on the side plate 124 having a cylindrical shape to suck-in the air from an outside of the cyclone air purifier. That is, the plurality of inlet holes 124s are formed on an entire circumferential surface of the side plate 124 to suck in the air in various directions around the cyclone air purifier. Also, the side plate 124 can have a function of pre-filtering and separating large sized-particles from the air.

A space is formed between the upper plate 122 and the lower plate 123 to provide an air path 125 to distribute the sucked-in air to the plurality of cyclones 110. An guide hole 122a is formed on the upper plate 122 so that the air sucked in the air path 125 between the upper plate 122 and the lower plate 123 through the inlet holes 124a of the side plate 124 is guided into each inside of the plurality of cyclones 110 through corresponding ones of the guide units 114 of the cyclone cover unit 121.

Each cyclone 110 formed on the first main body 100′ includes the cyclone body 111 having a tube or pipe shape. The tube or pipe-shaped cyclone body 111 of the cyclone 110 includes a circular cylindrical element 111a having a same diameter, and a cone-shaped element 111b extended from a lower portion of the circular cylindrical element 111a to narrow downward. A first discharging unit 111c is formed on a lower portion of the cone-shaped element 111b.

The cyclone cover unit 121 is provided with a cover 112 to cover an upper portion of the circular cylindrical element 111a of the cyclone body 111, and the second discharging unit 113 is formed at a central portion of the cover 112. The second discharging unit 113 includes a discharging element 113a formed on a central axis of the cyclone body 111, an upper protrusion 113b protruding upward, and a lower protrusion 113c protruding downward.

The guide unit 114 is formed to protrude upward from the cyclone cover unit 121 to guide the sucked-in air into the inside of the cyclone 110 from the air path 125, and may be formed in a semi-circular shape with respect to the second discharging unit 113.

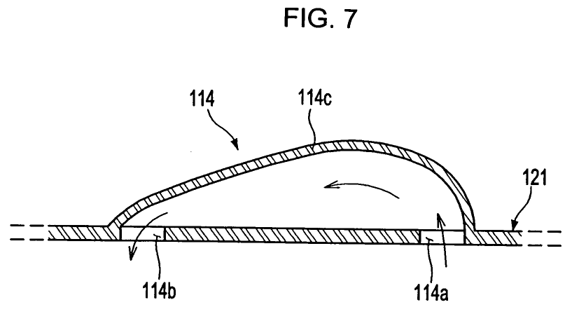

FIG. 7 is a cross-sectional view taken along a line VII-VII of FIG. 3 to illustrate the guide unit 114 of FIG. 3. Referring to FIG. 7, the guide unit 114 includes a first guide groove 114a to communicate with the air path 125, a second guide groove 114b to communicate with the inside of the cyclone 110, and a guide duct 114c connected between the first and second guide grooves 114a and 114b. The guide duct 114c has a height at a portion thereof disposed adjacent to the first guide groove 114a, and the height of the guide duct 113c becomes lowered when approaching the second guide groove 114b. That is, a depth of the first guide groove 114a is deeper that that of the second guide groove 114b. Accordingly, the air sucked in the guide unit 114 flows toward the second guide groove 114b, rotates in a downward direction, and flows in a downward and inclined direction when being sucked in the inside of the cyclone body 111 of the cyclone 110. The first guide groove 114a may be disposed to be spaced-apart from a center of the discharging element 113a by a first distance, and the second guide groove 114b is disposed to be space apart from the center of the discharging element 113a by a second distance. The second distance may be shorter than the first distance.

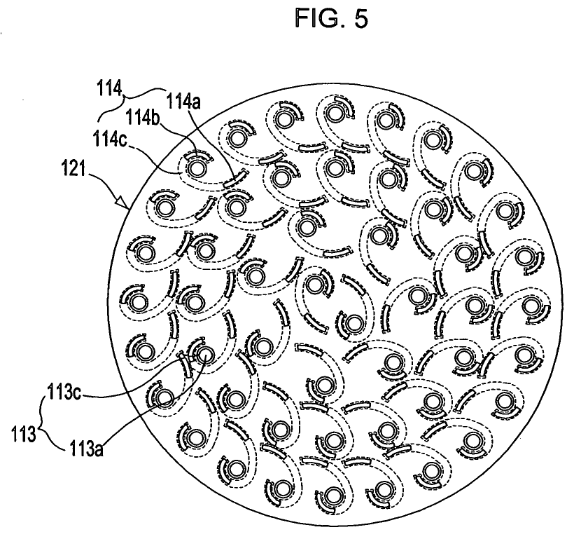

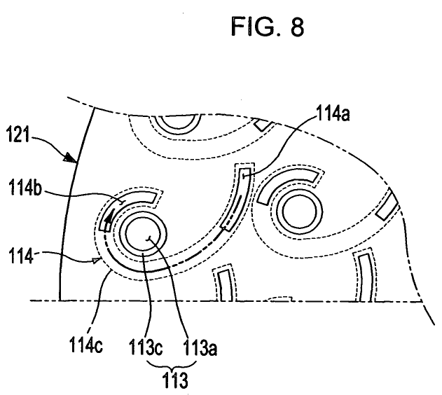

FIG. 8 is an enlarged bottom view of a portion of the cyclone cover unit 121 of the cyclone air purifier of FIG. 5 to illustrate the second discharging unit 113 and the guide unit 114. The first and second guide grooves 114a and 114b are disposed opposite to each other with respect to the central axis of the second discharging unit 113, and the second guide groove 114b is formed to face the inside of the cyclone body 111 of the cyclone 110.

Accordingly, the air is introduced into an inside of the circular cylindrical element 111a of the cyclone body 111, rotates in a spiral direction along an inside surface of the circular cylindrical element 111a to gradually descend, and flows into the cone-shaped element 111b. The air continues to rotate in the spiral direction within the cone-shaped element 111b so that heavy dust particles or pollutants are centrifugal-separated to be discharged downward through the first discharging unit 111c and collected into the dust collecting unit 205. The purified air ascends through a central inside portion of the cyclone 110 to be discharged into the inside of the discharge guide unit 201 through the second discharging unit 113.

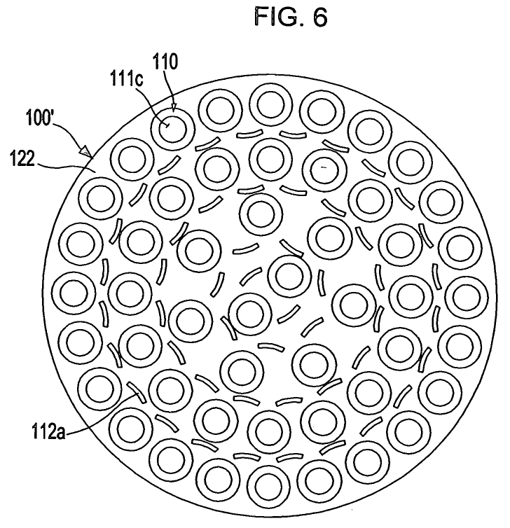

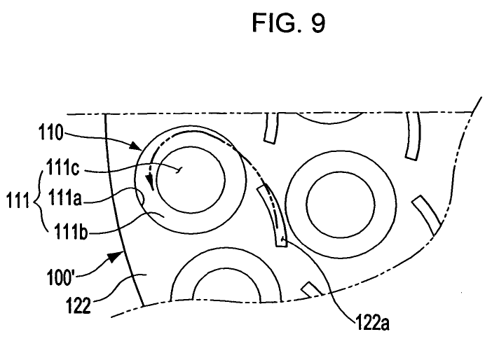

FIG. 9 is an enlarged view illustrating a portion of the upper plate 122 of the first main body 100′ of the air purifier of FIG. 6. As shown FIG. 9, the guide hole 122a is formed to correspond to the first guide groove 114a of the guide unit 114 so that the guide unit 114 communicates with the air path 125 through the first guide groove 114b and the guide hole 122a of the upper plate 122. Here, arrows shown in FIGS. 7 through 9 indicate directions in which the air flows.

The upper plate 122 of the first main body 100′ and the plurality of cyclone bodies 111 may be formed in a monolithic body. That is, the plurality of cyclone bodies 111 are formed on the upper plate 122 having a circular-shaped plate in a single body. The plurality of cyclones 110 are arranged on corresponding ones of a plurality of concentric circles as shown in FIG. 6.

That is, two cyclones 110 are disposed in a central area of the first main body 100′, seven cyclones 110 are disposed along one of the concentric circles outside the central area, and a number of cyclones 110 greater than seven are disposed to form corresponding ones of the concentric circles. Accordingly, a greater number of cyclones 110 can effectively be arranged within the main body 100.

In addition, the guide holes 122a formed on the upper plate 122 are disposed (arranged) close to corresponding ones of the cyclones 110. Since the guide holes 122 are disposed to correspond to the respective cyclones 110, the guide holes 122 form the same concentric circles as the cyclones 110.

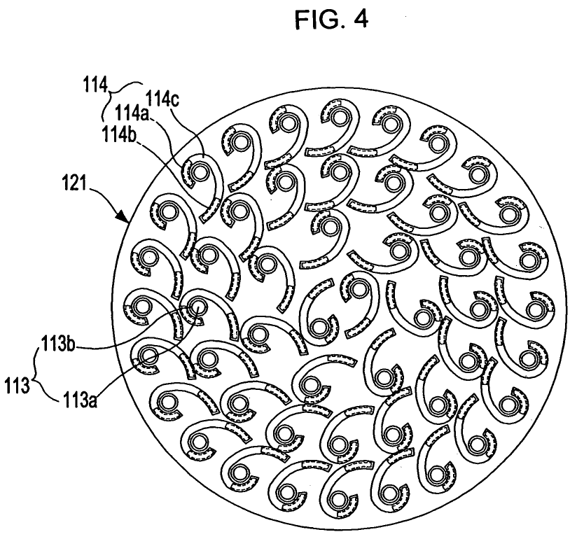

The guide units 114 of the cyclone cover unit 121 and the second discharge units 113 may be formed in an integrated body. That is, the guide units 114 and the second discharge units 113 are arranged to form the concentric circles to correspond to the respective cyclones 110 as shown in FIGS. 4 and 5.

As described above, since the plurality of cyclones 110 are arranged along the corresponding ones of the concentric circles, the plurality of cyclones 110 can be formed in even a compact structure. Moreover, since the plurality of cyclones 110 are formed when the integrated body of the upper plate 122 of the first main body 110′ is combined with the integrated body of the cyclone cover unit 121, manufacturing costs are reduced compared to separate manufacturing processes of the cyclones 110, the guide units 114, and the second discharging units 113.

An air flow within the main body 100 will be described hereinafter.

The contaminated air containing dust particles is introduced into the inside of the main body 100 through the inlet holes 124a of the side plate 124. The introduced air flows along the air path 125 and is distributed and introduced into the respective cyclones 110.

In more detail, the air introduced into the air path 125 through the inlet holes 124a of the side plate 124 is distributed by passing through the guide holes 122a formed on the upper plate 122 of the first main body 110′, and guided into the inside of each of the cyclones 110. That is, the air introduced into the first guide groove 114a of the guide unit 114 flows along the guide duct 114c having a spiral shape to start to form a spiral air current.

The air inside the guide unit 114 is introduced into the inside of the cyclone body 111 through the second guide groove 114b. The air introduced into the inside of the cyclone body 111 flows along the inside surfaces of the cylindrical element 111a and the cone-shaped element 111b of the cyclone body 111 to form a spiral dive air current.

When the spiral dive air current continues to descend, the dust particles contained in the air rotates along the spiral dive air current, is separated from the air by a centrifugal force and gravity, and is discharged through the first discharging unit 111c. The purified air from which the dust particles are separated forms an air ascending current in the central portion of the cyclone body 111 and to be discharged outside the main body 100 through the second discharging unit 113.

An operation of the cyclone air purifier will be explained hereinafter according to another embodiment of the present general inventive concept.

When the cyclone air purifier starts to operate, the fan motor 203 drives the ventilation fan 202 to rotate. The air surrounding the cyclone air purifier is sucked into the inside of the main body 100 by a sucking force of the ventilation fan 202. In the main body 100, the air sucked into the main body 100 is purified so that the separated dust particles are discharged into the dust collecting unit 205, and the purified air is discharged into the discharging guide unit 201. The purified air of the discharging guide unit 201 passes through the air filter 204 to remove the minute dirt or dust particles remaining in the purified air or to be discharged outside the cyclone air purifier after sterilization or deodorization.

As described above, the cyclone air purifier according to the embodiment of the present general inventive concept separates the dirt and dust particles from the sucked-in air using a cyclone principle to effectively purify the sucked-in air compared to a conventional filter-type air purifier. Since the sucked-in air does not have to pass through a plurality of filters, resistance against an air flow and noise from an air current are reduced significantly.

In addition, the air does not have to pass through the removed dirt and dust particles since the removed dirt and dust particles are collected in the dust collecting unit which is separately installed from a passage of the air, thereby improving an air purifying function.

Since the air is sucked into the cyclone air purifier through the inlet holes formed on an entire surface of the side plate, the air disposed around the cyclone air purifier in almost all directions can be purified.

According to an embodiment of the present general inventive concept, in the cyclone air purifier, the plurality of cyclones are arranged parallel to one another and disposed on corresponding ones of the concentric circles, thereby realizing a compact structure having a large air purifying ability.

According to an embodiment of the present general inventive concept, in the cyclone air purifier, a plurality of cyclone main body are integrated in a single body, and a plurality of guide units and a plurality of discharging units are formed on a single cyclone cover unit in an integrated body, thereby simplifying a manufacturing process.

According to an embodiment of the present general inventive concept, in the cyclone air purifier, since the dirt and dust particles are removed in the cyclone body, additional operation of cleaning or replacing a filter which is additionally installed can be reduced.

What is claimed is:

1. A cyclone air purifier comprising:
a main body having an air path and a plurality of cyclones disposed parallel to one another therein to communicate with the air path,
wherein the main body comprises a side plate having a plurality of inlet holes formed thereon to introduce an outside air containing particles into the air path of the main body, and each of the plurality of cyclones comprises a first discharging unit formed a lower portion thereof to guide discharge of the particles which are separated from the air, and a second discharging unit formed on an upper portion thereof to discharge the air.

2. The cyclone air purifier of claim 1, further comprising:
a plurality of guide units to guide the air of the air path into an inside of each of the plurality of cyclones.

3. The cyclone air purifier of claim 2, wherein each of the guide units is formed around the second discharging unit of each of the plurality of cyclones.

4. The cyclone air purifier of claim 2, wherein each of the guide units comprises:
a first guide groove disposed on an outside of a corresponding one of the plurality of cyclones to communicate with the air path;
a guide duct to guide the air introduced into the first guide groove toward the corresponding one of the plurality of cyclones; and
a second guide groove extended from the guide duct to communicate with an inside of the corresponding one of the plurality of cyclones.

5. The cyclone air purifier of claim 4, wherein the first guide groove has a first depth deeper than a second depth of the second guide groove.

6. The cyclone air purifier of claim 4, wherein the second guide groove is formed to face an inside surface of the corresponding one of the plurality of cyclones.

7. The cyclone air purifier of claim 4, wherein the first and second guide grooves are disposed opposite to each other with respect to the second discharging unit.

8. The cyclone air purifier of claim 1, wherein the second discharge unit comprises a lower protrusion to protrude downward toward an inside of the corresponding one of the plurality of cyclones.

9. The cyclone air purifier of claim 1, further comprising:
a collector disposed on a lower portion of the main body to collect the separated particles discharged through the first discharging unit of the corresponding one of the plurality of cyclones.

10. The cyclone air purifier of claim 1, further comprising:
a discharging guide unit disposed on an upper portion of the main body to receive the purified air from the plurality of cyclones and to discharge the received purified air.

11. The cyclone air purifier of claim 10, wherein the discharging guide unit comprises:
a ventilation fan installed therein.

12. The cyclone air purifier of claim 10, wherein the discharging guide unit comprises:
a filter installed therein.

13. The cyclone air purifier of claim 1, wherein the inlet holes are dispersed and arranged on the side plate so that the outside air around the main body is sucked-in through the inlet holes.

14. The cyclone air purifier of claim 1, wherein the inlet holes are dispersed and arranged along an entire circumference of the side plate so that the outside air is sucked-in throughout the entire circumference.

15. The cyclone air purifier of claim 1, wherein the plurality of cyclones are disposed on corresponding ones of concentric circles.

16. A cyclone air purifier comprising:
a first main body having an upper plate, a lower plate to form an air path with the upper plate, a side plate formed with a plurality of inlet holes through which an outside air is introduced into the air path, and having a cylindrical shape;
a plurality of cyclone bodies disposed parallel to one another in the first main body to communicate with the air path, and having an upper portion disposed in an opening of the upper plate, and a lower portion to pass through the lower plate to form a first discharging unit; and
a second main body having cover portions to cover corresponding ones of the openings of the upper plates, and having second discharging units formed on the respective cover portions to guide discharge of purified air from a corresponding one of the plurality of cyclones.

17. The cyclone air purifier of claim 16, wherein the first main body comprises a guide hole formed on the upper plate outside the corresponding one of the plurality of cyclone bodies, and the second main body comprises a plurality of guide units to guide the air, introduced from the air path through the guide hole, into an inside of the corresponding one of the plurality of cyclone bodies.

18. The cyclone air purifier of claim 17, wherein each of the guide units is formed around a corresponding one of the second discharging units.

19. The cyclone air purifier of claim 17, wherein each of the guide units comprises
a first guide groove disposed on an outside of a corresponding one of the plurality of cyclone bodies to communicate with the air path;
a guide duct to guide the air introduced into the first guide groove toward the corresponding one of the plurality of cyclone bodies; and
a second guide groove extended from the guide duct to communicate with an inside of the corresponding one of the plurality of cyclone bodies.

20. The cyclone air purifier of claim 19, wherein the first guide groove has a first depth deeper than a second depth of the second guide groove.

21. The cyclone air purifier of claim 19, wherein the second guide groove is formed to face an inside surface of the corresponding one of the plurality of cyclone bodies.

22. The cyclone air purifier of claim 19, wherein the first and second guide grooves are disposed opposite to each other with respect to the second discharging unit.

23. The cyclone air purifier of claim 17, wherein the second discharge unit comprises a lower protrusion to protrude downward toward an inside of a cyclone body of the corresponding one of the plurality of cyclone bodies.

24. The cyclone air purifier of claim 16, wherein the upper plate of the first main body and the plurality of cyclone bodies are formed in an integrated single body.

25. The cyclone air purifier of claim 17, further comprising:
a collector disposed on a lower portion of the first main body to collect the separated particles discharged through the first discharging unit of the corresponding one of the plurality of cyclones.

26. The cyclone air purifier of claim 16, further comprising:
a discharging guide unit disposed on an upper portion of the second main body to receive the purified air from the plurality of cyclone bodies and to discharge the received purified air.

27. The cyclone air purifier of claim 26, wherein the discharging guide unit comprises:
a ventilation fan installed therein.

28. The cyclone air purifier of claim 26, wherein the discharging guide unit comprises:
a filter installed therein.

29. The cyclone air purifier of claim 16, wherein the inlet holes are dispersed and arranged on the side plate so that the outside air is sucked in directions throughout a circumstance of the side plate.

30. The cyclone air purifier of claim 16, wherein the second main body comprises a plate shape formed by combining the cover portions and the second discharging units in an integrated single body.

31. The cyclone air purifier of claim 16, wherein the plurality of cyclones are disposed on corresponding ones of concentric circles.

32. An air purifier, comprising:
an inlet;
a main body having first and second plate units to form an air path therebetween to receive air and particles through the inlet, and a plurality of cyclones each having a cyclone body, a guide hole formed on the second plate unit through which the air and particles are introduced from the air path into an inside of the cyclone body, a first discharge unit formed on a first end of the cyclone body to discharge the particles from the inside of the cyclone body to a first outside of the main body through the first plate unit, and a second discharge unit formed on a second end of the cyclone body to discharge the air from the inside of the cyclone body to a second outside of the main body through the second plate unit;
a collecting unit disposed to receive the particles which have been discharged from the inside of the cyclone body to the first outside of the main body through the first discharge unit; and
a discharging guide unit to receive the air which has been discharged from the inside of the cyclone body to the second outside of the main body through the second discharge unit.

33. The air purifier of claim 32, wherein the plurality of cyclones have central axes parallel to each other, and centers of the first and second discharge units of each cyclone are disposed parallel to a corresponding one of the central axes.

34. The air purifier of claim 32, wherein the first end of the cyclone body protrudes from the first plate unit toward the collecting unit to form the first discharge unit.

35. The air purifier of claim 32, wherein the second end of the cyclone body protrudes from the second plate unit toward the discharge guide unit to form the second discharge unit.

36. The air purifier of claim 32, further comprising:
a fan motor unit to discharge the air contained in the discharge guide unit outside the air purifier.

37. The air purifier of claim 36, wherein the plurality of cyclones are disposed in a first direction, and the first and second plate units, the main body, the collecting unit, the discharge guide unit, and the fan motor unit are disposed in a second direction.

38. The air purifier of claim 36, wherein the first and second plate units are disposed in the first direction to form the air path.

39. The air purifier of claim 32, wherein the each cyclone further comprises a guide unit having a first guide groove to receive the air and particles through the guide hole, a second guide groove, and a guide duct formed between the first and second guide grooves, so that the air and the particles are introduced from the air path into the inside of the cyclone body through the guide hole, the first guide groove, the guide duct, and the second guide groove in order.

40. The air purifier of claim 39, wherein the first guide groove is spaced apart from a central axis of the cyclone body by a first distance, and the second guide groove is spaced apart from the central axis of the cyclone body by a second distance longer than the first distance.

41. The air purifier of claim 39, wherein the first guide groove, the second guide groove, and the guide duct are disposed on an eccentric line of a central axis of the cyclone body.

42. The air purifier of claim 32, wherein the each cyclone further comprises a guide unit disposed around the second discharge unit to introduce the air and particles into the inside of the cyclone body through the guide hole.

43. The air purifier of claim 32, wherein the main body further comprises a side plate formed with the inlet having inlet holes.

44. The air purifier of claim 32, wherein the air purifier comprises a cylindrical shape having a side, a bottom, a top, and a middle, and the side plate, the collecting unit, the discharging guide unit, and the main body correspond to portions of the side, bottom, top, and middle, respectively.

45. The air purifier of claim 32, wherein center lines of the plurality of cyclones are perpendicular to the at least one of the first and second plate units.

46. The air purifier of claim 32, wherein the plurality of cyclones are disposed in a circumferential direction of the main body.
